(19) United States
(12) Patent Application Publication
(10) Pub. No.: US 2017/0276987 A1
(43) Pub. Date: Sep. 28, 2017

(54) OPTICAL MEMBER AND IMAGE DISPLAY DEVICE INCLUDING OPTICAL MEMBER

(71) Applicant: FUJIFILM Corporation, Tokyo (JP)

(72) Inventor: Shunya KATOH, Kanagawa (JP)

(73) Assignee: FUJIFILM Corporation, Tokyo (JP)

(21) Appl. No.: 15/617,395

(22) Filed: Jun. 8, 2017

Related U.S. Application Data
(63) Continuation of application No. PCT/JP2015/084590, filed on Dec. 10, 2015.

(30) Foreign Application Priority Data
Dec. 11, 2014 (JP) 2014-251213

(51) Int. Cl. G02F 1/1333; G02F 1/1337

(52) U.S. Cl. CPC G02F 1/13338; G02F 1/1337; G02F 2202/023; G02F 2001/133738; G02F 2203/05; G02F 2203/02

(57) ABSTRACT

An optical member includes: a substrate; and a dot that is in contact with a surface of the substrate, in which the dot is formed of a liquid crystal material having a cholesteric structure, the substrate includes a liquid crystal layer that is formed on the surface in contact with the dot, and the liquid crystal layer is a layer in which orientation of a liquid crystal compound is immobilized. The optical member includes a dot in a shape having a large maximum height with respect to a diameter, the dot being formed of a liquid crystal material having a cholesteric structure in which orientation disorder is reduced. As a result, the detection sensitivity of the dot pattern in various directions including an oblique direction is high. By using the optical member according to the present invention, an image display device having a high data input sensitivity can be provided.

### CROSS-REFERENCE TO RELATED APPLICATIONS

This application is a continuation of PCT International Application No. PCT/JP2015/084590 filed on Dec. 10, 2015, which claims priority under 35 U.S.C §119 (a) to Japanese Patent Application No. 2014-251213 filed on Dec. 11, 2014, the entire content of which is incorporated herein by reference.

### BACKGROUND OF THE INVENTION

1. Field of the Invention

The present invention relates to an optical member and an image display device including the optical member.

2. Description of the Related Art

Recently, the necessity of a system in which data is handwritten on a display of an image display device using an electronic pen or the like to input data has increased. JP2009-28953A discloses a transparent sheet in which a dot pattern formed of a transparent ink is printed on a transparent substrate, in which the transparent ink includes a liquid crystal material having a cholesteric structure which selectively reflects infrared light. This transparent sheet can be used in the above-described system when mounted in a display device and used in combination with an electronic pen, the electronic pen including: an infrared sensor that detects reflected light from the dot pattern; and an infrared irradiating portion.

### SUMMARY OF THE INVENTION

The liquid crystal material having a cholesteric structure has wavelength selective reflecting properties which are the highest in a helical axis direction of the cholesteric structure. For example, in a case where the transparent sheet is formed in a plane shape, the maximum reflecting properties at a desired wavelength are exhibited in a normal direction perpendicular to the plane. Therefore, in a case where reflected light is read in an oblique direction using the electronic pen or the like in the system, the intensity of the reflected light is not strong, and it is difficult to obtain a high sensitivity. In the transparent sheet disclosed in JP2009-28953A, by using a liquid repellent layer as an underlayer for forming a dot, an ink droplet swells in a substantially hemispherical shape, and a surface thereof is largely curved. Due to this shape, data can be read from an oblique direction with a high sensitivity.

On the other hand, in order to form a cholesteric structure of a liquid crystal material having high selective reflecting properties, it is preferable that orientation disorder of a liquid crystal compound is reduced. Therefore, a layer having a cholesteric structure is formed on a surface of an alignment film or the like. The liquid repellent layer described in JP2009-28953A is formed of a composition including a crosslinking monomer and does not have a function as an alignment film Therefore, in the transparent sheet described in JP2009-28953A, it is considered that sufficient selective reflecting properties corresponding to a material of the dot are not obtained.

An object of the present invention is to provide an optical member including a dot pattern which is formed of a liquid crystal material having a cholesteric structure, in which the detection sensitivity of the dot pattern in various directions including an oblique direction is high. Specifically, the object is to provide an optical member which includes a dot in a shape having a large maximum height with respect to a diameter, the dot being formed of a liquid crystal material having a cholesteric structure in which orientation disorder is reduced. Another object of the present invention is to provide an image display device which is capable of inputting data and has a high data input sensitivity.

The present inventors performed a thorough investigation in order to achieve the objects and found that, by using a layer in which a liquid crystal compound is oriented as an underlayer for forming a dot, a dot having excellent orientation of a liquid crystal material and a large maximum height with respect to a diameter can be formed, thereby completing the present invention.

That is, the present invention provides the following [1] to [16].

[1] An optical member comprising:

a substrate; and

a dot that is in contact with a surface of the substrate,

in which the dot is formed of a liquid crystal material having a cholesteric structure,

the substrate includes a liquid crystal layer that is formed on the surface in contact with the dot, and

the liquid crystal layer is a layer in which orientation of a liquid crystal compound is

[2] The optical member according to [1],

in which the liquid crystal layer is a layer in which horizontal alignment of a rod-shaped liquid crystal compound is immobilized.

[3] The optical member according to [2],

in which the liquid crystal layer is a cured layer of a composition including a rod-shaped polymerizable liquid crystal compound.

[4] The optical member according to any one of [1] to [3],

in which the liquid crystal layer includes a surfactant.

[5] The optical member according to any one of [1] to [4],

in which the substrate includes an alignment film, and

the liquid crystal layer and the alignment film are in direct contact with each other.

[6] The optical member according to any one of [1] to [5],

in which the substrate includes a support.

[7] The optical member according to any one of [1] to [6],

in which the liquid crystal material is a material obtained by curing a liquid crystal composition including a liquid crystal compound and a chiral agent.

[8] The optical member according to [7],

in which the liquid crystal composition includes a surfactant.

[9] The optical member according to [8],

in which the surfactant is a fluorine surfactant.

[10] The optical member according to any one of [1] to [9],

in which a plurality of the dots are provided in a pattern shape on the surface of the substrate.

[11] The optical member according to any one of [1] to [10],

in which a diameter of the dot is 20 to 200 μm.

[12] The optical member according to any one of [1] to [11],

in which a value obtained by dividing a maximum height of the dot by the diameter of the dot is 0.13 to 0.30.

[13] The optical member according to any one of [1] to [12],

in which the dot has wavelength selective reflecting properties in which a center wavelength is present in an infrared range.

[14] The optical member according to claim [13],

in which the dot has wavelength selective reflecting properties in which a center wavelength is present at a wavelength of 800 to 950 nm.

[15] The optical member according to any one of [1] to [14] which is transparent.

[16] An image display device comprising the optical member according to [15].

According to the present invention, a new optical member is provided. For example, the optical member according to the present invention is attached to an image display device such that it can be used for directly handwriting data on the image display device using an electronic pen or the like to input data. By using the optical member according to the present invention, even in a case where an operation using an electronic pen or the like is performed in an oblique direction, data can be input with a high sensitivity.

### BRIEF DESCRIPTION OF THE DRAWINGS

FIGS. 1A and 1B are diagrams showing examples of an optical member according to the present invention, in which FIG. 1A shows a cross-section of an example not including an overcoat layer, and FIG. 1B shows a cross-section of an example including an overcoat layer.

FIG. 2 is a schematic diagram showing a system in which the optical member according to the present invention is used as a sheet which is mounted on or in front of a surface of an image display device (image-displayable device).

FIG. 3 is an image showing retroreflection of an optical member according to Example 1 at a polar angle of 5°, in which the center of each dot exhibits green reflection.

FIG. 4 is a diagram showing images of a cross-section of a dot of an optical member prepared in Example when observed with a scanning electron microscope (SEM).

### DESCRIPTION OF THE PREFERRED EMBODIMENTS

Hereinafter, the present invention will be described in detail.

In this specification, numerical ranges represented by “to” include numerical values before and after “to” as lower limit values and upper limit values.

In this specification, for example, unless specified otherwise, an angle such as “45°”, “parallel”, “perpendicular”, or “orthogonal” represents that a difference from an exact angle is less than 5°. The difference from an exact angle is preferably less than 4 degrees and more preferably less than 3 degrees.

In this specification, “(meth)acrylate” represents “either or both of acrylate and methacrylate”.

In addition, in this specification, numerical values, numerical ranges, and qualitative expressions (for example, the expression “the same”) implies numerical values, numerical ranges, and properties including errors which are generally allowable in the technical field. In particular, in this specification, the meaning of “all”, “entire”, or “entire surface” includes not only 100% hut also a case where an error range is generally allowable in the technical field, for example, 99% or more, 95% or more, or 90% or more.

Visible light refers to light which can be observed by human eyes among electromagnetic waves and refers to light in a wavelength range of 380 nm to 780 nm Invisible light refers to light in a wavelength range of shorter than 380 nm or longer than 780 nm.

Among infrared light rays, near infrared light refers to an electromagnetic wave in a wavelength range of 780 nm to 2500 nm. Ultraviolet light refers to light in a wavelength range of 10 to 380 nm.

In this specification, retroreflection refers to reflection in which incident light is reflected in an incidence direction.

In this specification, “polar angle” refers to an angle with respect to a normal line perpendicular to a substrate.

In this specification, a surface of a dot refers to a surface or an interface of the dot opposite to a substrate, which is a surface in contact with the substrate. An end portion of a dot does not interfere with contact between a surface of a dot and the substrate.

“Transparent” described in this specification represents that the light transmittance is preferably 50% or higher, more preferably 70% or higher, and still more preferably 85% or higher.

The light transmittance refers to a visible transmittance obtained using a method described in JIS A5759. That is, the visible transmittance is obtained by Measuring a transmittance at a wavelength of 380 nm to 780 nm using a spectrophotometer and multiplying the measured transmittance by a weigthing factor to obtain a weighted average, the weigthing factor being obtained based on a spectral distribution of daylight D65 defined by The International Commission on Illumination (CIE) and a wavelength distribution and a wavelength interval of spectral luminous efficiency function for photopic vision defined by CIE.

In this specification, “haze” refers to a value measured using a haze meter NDH-2000 (manufactured by Nippon Denshoku Industries Co., Ltd.).

Theoretically, haze refers to a value expressed by the following expression, (Diffuse Transmittance of Natural Light at 380 to 780 nm)/(Diffuse Transmittance of Natural Light at 380 to 780 nm+Parallel Transmittance of Natural Light)×100%

The diffuse transmittance refers to a value calculated by subtracting the parallel transmittance from a total transmittance which is obtained using a spectrophotometer and an integrating sphere unit. The parallel transmittance refers to a transmittance at 0° in a case where a value measured using an integrating sphere unit is used.

<Optical Member>

The optical member includes a substrate and a dot that is formed on the substrate.

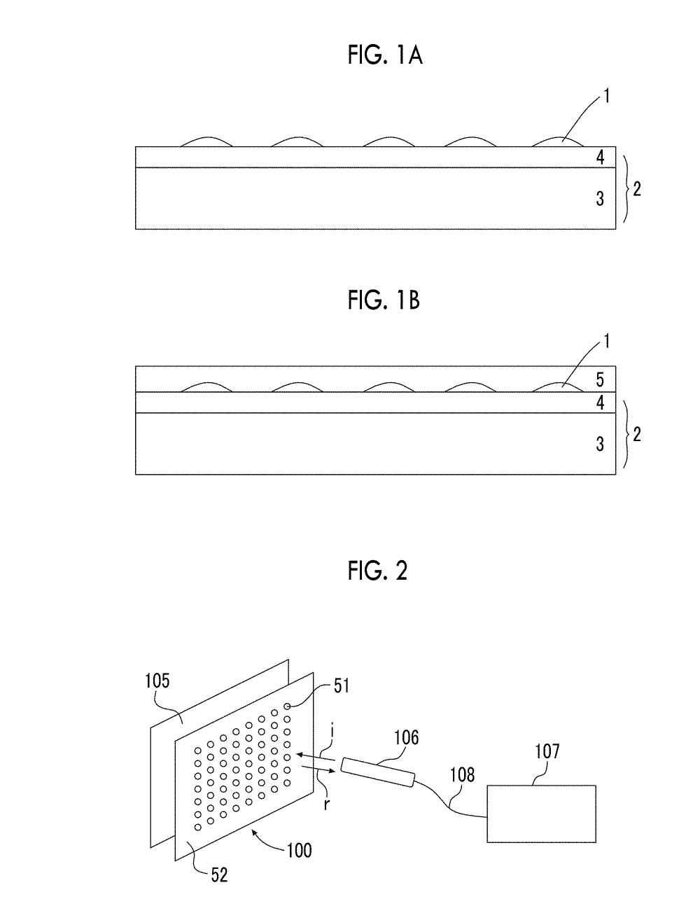

The shape of the optical member is not particularly limited and is, for example, a film shape, a sheet shape, or a plate shape. FIGS. 1A and 1B are cross-sectional views schematically showing examples of the optical member according to the present invention. In the example shown in FIG. 1A, dots 1 are formed on a liquid-crystal-side surface of a substrate 2 including a support 3 and a liquid crystal layer 4. In an example shown in FIG. 1B, an overcoat layer 5 is provided on the dot-formed surface side of the substrate so as to cover the dots 1.

The optical member according to the present invention may be transparent or not in the visible range depending on the application and is preferably transparent.

In the optical member according to the present invention, the upper limit of the haze is preferably 5% or lower, more preferably 3% or lower, and still more preferably 2% or lower.

<Substrate>

The substrate included in the optical member according to the present invention functions as a substrate for forming the dot on the surface of the underlayer.

It is preferable that the reflectance of the substrate is low at a wavelength where the dot reflects light, and it is preferable that the substrate does not include a material which reflects light at a wavelength where the dot reflects light.

In addition, it is preferable that the substrate is transparent in the visible range. In addition, the substrate may be colored. However, it is preferable that the substrate is not colored or the area of the substrate colored is small. Further, the refractive index of the substrate is preferably about 1.2 to 2.0 and more preferably about 1.4 to 1.8. The above-described configurations are made in order to prevent deterioration in the visibility of an image displayed on a display in a case where the optical member is used for, for example, a front surface of the display.

It is preferable that the reflectance of each of the layers in the substrate is low at a wavelength where the dot reflects light, and it is preferable that each of the layers in the substrate does not include a material which reflects light at a wavelength where the dot reflects light. In addition, it is preferable that each of the layers in the substrate is transparent. Further, the refractive index of each of the layers is preferably about 1.2 to 2.0 and more preferably about 1.4 to 1.8.

The thickness of the substrate may be selected depending on the application without any particular limitation, and is preferably about 5 μm to 1000 μm, more preferably 10 μm to 250 μm, and still more preferably 15 μm to 150 μm.

The substrate includes a liquid crystal layer. The substrate may consist of only a liquid crystal layer. It is preferable that the substrate includes a support and a liquid crystal layer or includes a support, an alignment layer, and a liquid crystal layer.

<Liquid Crystal Layer>

The liquid crystal layer is a layer included in the substrate and is positioned on the outermost surface of the substrate. The dot is formed on the surface of the substrate where the liquid crystal layer is provided. That is, the liquid crystal layer and the dot are disposed in contact with each other.

The liquid crystal layer is a layer in which orientation of a liquid crystal compound is immobilized. The present inventors found that the liquid crystal layer functions not only as an underlayer that exhibits liquid repellency required to form a dot shape but also as an alignment layer for forming a cholesteric structure. In the related art, cholesteric orientation is formed by applying a cholesteric structure-forming composition to a surface of an alignment film or a rubbed surface of a substrate. However, the surface of the alignment film or the rubbed surface of the substrate does not have liquid repellency required to form a dot shape. Examples shown below show that, in a case where a liquid crystal layer was used, a dot exhibited high retroreflection properties with respect to light incident on the dot with a polar angle of 5° and light incident on the dot with a polar angle of 30°. The reason for this presumed to be that the liquid crystal layer has excellent liquid repellency and orientation as an underlayer for forming a dot shape and causes a dot to be formed in a shape having a large maximum height with respect to a diameter, the dot being formed of a liquid crystal material having a cholesteric structure in which orientation disorder is reduced.

The liquid crystal layer is a layer in which orientation of the liquid crystal compound is aligned, and typically has a front phase difference. The front phase difference at a predetermined wavelength can be measured using KOBRA 21ADH or WR (manufactured by Oji Scientific Instruments Co., Ltd.) by causing light at the predetermined wavelength to be incident in a film normal direction. The front phase difference of the liquid crystal layer is not particularly limited and may be, for example, 0.1 nm to 1000 nm, 1 nm to 500 nm, or 5 nm to 300 nm. The front phase difference may be adjusted depending on the use of the optical member or depending on an image display device into which the optical member is incorporated.

The thickness of the liquid crystal layer is not particularly limited and is preferably 0.01. μm. to 5 μm and more preferably 0.05 μm to 3 μm.

[Method of Forming Liquid Crystal Layer]

The liquid crystal layer can be formed, for example, by applying a liquid crystal composition described below to a surface of the support, the alignment layer, or the like, drying the liquid crystal composition, and optionally curing the liquid crystal composition. The liquid crystal layer may be obtained by preparing a temporary support and then peeling the temporary support off.

A method of applying the liquid crystal composition is not particularly limited and can be appropriately selected depending on the purpose. Examples include a wire bar coating method, a curtain coating method, an extrusion coating method, a direct gravure coating method, a reverse gravure coating method, a die coating method, a spin coating method, a dip coating method, a spray coating method, and a slide coating method.

(Drying of Liquid Crystal Composition)

The liquid crystal composition applied to the surface of the substrate is optionally dried. The liquid crystal composition may be heated for drying or may be dried and then heated. In a drying or heating step, the liquid crystal compound in the liquid crystal composition only has to be oriented. It is preferable that the orientation of the liquid crystal compound in the liquid crystal composition is horizontally aligned with respect to a surface of the substrate. It is preferable that the liquid crystal layer is a layer in which the horizontal alignment of the liquid crystal compound is immobilized. Due to the horizontal alignment, a nematic phase may be formed. At this time, it is preferable that the liquid crystal compound is a rod-shaped liquid crystal compound. The nematic phase refers to a state where liquid crystal molecules have orientational order but no three-dimensional positional order.

In the case of heating, the heating temperature is preferably 50° C. to 120° C. and more preferably 60° C. to 100° C.

(Curing of Liquid Crystal Composition)

In a case where the liquid crystal composition is a polymerizable liquid crystal compound, the oriented polymerizable liquid crystal compound may be polymerized by curing the liquid crystal composition. The liquid crystal composition may be cured by light irradiation or heating and preferably by light irradiation. Regarding the light irradiation, ultraviolet light is preferably used. The irradiation energy is preferably 20 mJ/cm² to 50 mJ/cm² and more preferably 100 mJ/cm² to 1500 mJ/cm². In order to promote a photopolymerization reaction, light irradiation may be performed under heating conditions or in a nitrogen atmosphere. The wavelength of irradiated ultraviolet light is preferably 250 nm to 430 nm. From the viewpoint of stability, the polymerization degree is preferably high, and is preferably 70% or higher and more preferably 80% or higher. The polymerization degree can be determined by obtaining a consumption ratio between polymerizable functional groups using an IR absorption spectrum.

<Support>

The substrate may include a support. Examples of the support include glass, triacetyl cellulose (TAC), polyethylene terephthalate (PET), poly/carbonates, polyvinyl chloride, acryl, and polyolefin.

<Alignment Layer>

The substrate may include an alignment layer. In the substrate including the support, the alignment layer may be provided between the support and the liquid crystal layer. At this time, it is preferable that the alignment layer is in direct contact with the liquid crystal layer and the support. The alignment layer can be provided, for example, by the following means: rubbing of an organic compound such as a polymer (a resin such as polyimide, polyvinyl alcohol, polyester, polyarylate, polyamide imide, polyether imide, polyamide, or modified polyamide); oblique angle deposition of an inorganic compound; formation of a microgroove layer; or accumulation of an organic compound (for example, ω-tricosanoic acid, dioctadecylmethylammonium chloride, or methyl stearate) using the Langmuir-Blodgett technique (LB technique). Further, an alignment layer which functions by imparting of an electric field, imparting of a magnetic field, or light irradiation may also be used.

In particular, in the case of an alignment layer formed of a polymer, it is preferable that a surface of a polymer is rubbed and then the liquid crystal composition is applied to the rubbed surface. The rubbing treatment can be performed by rubbing a surface of a polymer layer with paper or fabric in a given direction multiple times.

Instead of providing the alignment layer, the liquid crystal layer may be formed on a surface of the support or a rubbed surface of the support.

The thickness of the alignment layer is preferably 0.01 to 5 μm and more preferably 0.05 to 2 μm.

<Dot>

The optical member according to the present invention includes a dot that is formed on a surface of the substrate. The dot may be formed on a single surface or both surfaces of the substrate and is preferably formed on a single surface thereof.

One dot or two or more dots may be formed on the surface of the substrate. Two or more dots may be provided to be adjacent to each other on the surface of the substrate such that the total surface area of the dots is 50% or more, 60% or more, or 70% or more with respect to the area of the surface of the substrate where the dots are formed. For example, in this case, the optical characteristics of the dots such as selective reflecting properties may match with the optical characteristics of substantially the entire area of the optical member, in particular, the entire area of the surface where the dots are formed. On the other hand, two or more dots may be provided to be distant from each other on the surface of the substrate such that the total surface area of the dots is less than 50%, 30% or less, or 10% or less with respect to the area of the surface of the substrate where the dots are formed. For example, in this case, the optical characteristics of the surface of the optical member where the dots are formed may be recognized as a contrast between the optical characteristics of the substrate and the optical characteristics of the dots.

A plurality of dots are formed in a pattern shape and may have a function of presenting information. For example, by forming the dots so as to provide position information on an optical member which is formed in a sheet shape, the optical member can be can be used as a sheet which can be mounted on a display and is capable of inputting data.

In a case where the dots are formed in a pattern shape, for example, a plurality of dots having a diameter of 20 to 200 μm are formed, 10 to 100 dots, preferably 15 to 50 dots, and more preferably 20 to 40 dots are provided on average in a square having a size of 2 mm×2 mm on the substrate surface.

In a case where a plurality of dots are provided on a surface of the substrate, the dots may have the same diameter and shape or different diameters and shapes and preferably has the same diameter and shape in order to obtain uniform reflected light from the respective dots. For example, it is preferable that the dots are formed under the same conditions for forming the dots having the same diameter and shape.

In this specification, the description of the dot is applicable to all the dots in the optical member according to the present invention. Further, it is allowable that the optical member according to the present invention including the above-described dots also includes a dot which deviates from the above description due to an error which is allowable in the technical field.

[Shape of Dot]

The shape of the dot is not particularly limited and is preferably is circular when observed from a normal direction perpendicular to the substrate. The circular shape is not necessarily a perfect circle and may be a substantially circular shape or an elliptical shape. For example, a shape in which a plurality of circles overlap each other while being slightly shifted from each other may be adopted. The center of the dot described herein refers to the center of the circle or the center of gravity. In a case where a plurality of dots are present on the surface of the substrate, the shapes of the dots may be the same as or different from each other and are preferably the same as or at least similar to each other.

The diameter of the dot film is preferably 20 to 200 μm and more preferably 30 to 150 μm. In a case where the dot is not circular, the dot is approximated to a circle to measure or calculate the diameter thereof.

The diameter of the dot can be obtained by measuring the length of a line, which ranges from an end portion (an edge or a boundary of the dot) to another end portion and passes through the center of the dot, in an image obtained using a microscope such as a laser microscope, a scanning electron microscope (SEM), or a transmission electron microscope (TEM). The number of dots and the distance between dots can be obtained from a microscopic image obtained using a laser microscope, a scanning electron microscope (SEM), or a transmission electron microscope (TEM)

It is preferable that the dot includes a portion having a height which continuously increases to a maximum height in a direction moving from an end portion of the dot to the center of the dot. In this specification, the above portion will also be referred to as the inclined portion or the curved portion. That is, it is preferable that the dot includes an inclined portion, a curved portion, or the like whose height increases from an end portion of the dot to the center of the dot.

“The height” of the dot described in this specification refers to “the shortest distance from a point of a surface of the dot to a surface of the substrate where the dot is formed”. In addition, in a case where the substrate has convex and concave portions, a surface of an end portion of the dot extending from the substrate is set as the surface where the dot is formed. The maximum height refers to a maximum value of the height which is, for example, the shortest distance from the peak of the dot to the surface of the substrate where the dot is formed. The height of the dot can be obtained from a cross-sectional view of the dot which is obtained by focal position scanning using a laser microscope or obtained using a microscope such as a SEM or a TEM.

Examples of a shape of a structure including the inclined portion or the curved portion include a hemispherical shape in which the substrate side is planar, a shape (spherical segment shape) in which the top of the hemispherical shape is cut and smoothened to be substantially parallel to the substrate, a conical shape having a bottom on the substrate side, a shape (truncated conical shape) in which the top of the conical shape is cut and smoothened to be substantially parallel to the substrate, and a shape which can be approximated to one of the above shapes. Among these shapes, a hemispherical shape in which the substrate side is planar, a shape in which the top of the hemispherical shape is cut and smoothened to be substantially parallel to the substrate, a shape in which the top of a conical shape having a bottom on the substrate side is cut and smoothened to be substantially parallel to the substrate, or a shape which can be approximated to one of the above shapes is preferable. The hemispherical shape represents not only a hemispherical shape in which a surface including the center of a sphere is planar but also any one of spherical segment shapes obtained by cutting a sphere into two segments at an arbitrary position.

A point of the dot surface for obtaining the maximum height of the dot may be present at the peak of a hemispherical shape or a conical shape or may be present on a surface which is cut and smoothened to be substantially parallel to the substrate. It is preferable that the maximum height of the dot is obtained at all the points of the smooth surface. It is also preferable that the maximum height is obtained at the center of the dot.

It is preferable that a value (maximum height/diameter) obtained by dividing the maximum height by the diameter of the dot is 0.13 to 0.30. It is preferable that the above-described condition is satisfied particularly in a shape in which the height of the dot continuously increases to the maximum height from an end portion of the dot and in which the maximum height is obtained at the center of the dot, for example, a hemispherical shape in which the substrate side is planar, a shape in which the top of the hemispherical shape is cut and flattened to be substantially parallel to the substrate, or a shape in which the top of a conical shape having a bottom on the substrate side is cut and flattened to be substantially parallel to the substrate. The ratio maximum height/diameter is more preferably 0.16 to 0.28.

In addition, an angle (for example, an average value) between a surface of the dot and the substrate (surface of the substrate where the dot is formed) is preferably 27° to 62° and more preferably 29° to 60°. By setting the angle in the above-described range, the dot can be made to exhibit high retroreflection properties at a light incidence angle which is suitable for the applications of the optical member described below.

The angle can be obtained from a cross-sectional view of the dot which is obtained by focal position scanning using a laser microscope or obtained using a microscope such as a SEM or a TEM. In this specification, in a SEM image of a cross-sectional view of a surface of the dot perpendicular to the substrate including to the center of the dot, the angle of a contact portion between the substrate and the dot surface is measured.

[Optical Characteristics of Dot]

In the optical member according to the present invention, the dot exhibits wavelength selective reflecting properties.

Light where the dot exhibits selective reflecting properties is not particularly limited. For example, any one of infrared light, visible light, and ultraviolet light may be used.

For example, in a case where the optical member is attached to a display device and is used for directly handwriting data on the display device to input data, the wavelength of light to which the dot exhibits selective reflecting properties is preferably a wavelength in the invisible range, more preferably a wavelength in the infrared range, and still more preferably a wavelength in the near infrared range in order not to adversely affect a display image. For example, it is preferable that a spectrum of reflection from the dot shows a reflection wavelength range in which a center wavelength is present in a wavelength range of 750 to 2000 nm and preferably 800 to 1500 nm. It is also preferable that the reflection wavelength is selected based on a wavelength of light emitted from a light source which is used in combination or a wavelength of light which is detected by a image pickup element (sensor).

In addition, for example, in a case where the optical member according to the present invention is used as a transparent screen, it is preferable that light where the dot exhibits selective reflecting properties is in the visible range. It is preferable that the reflection wavelength is selected depending on light irradiated from an imaging device into which the optical member according to the present invention is incorporated.

It is preferable that the dot is transparent in the visible range. In addition, the dot may be colored. However, it is preferable that the dot is not colored or the area of the dot colored is small. The above-described configurations are made in order to prevent deterioration in the visibility of an image displayed on a display in a case where the optical member is used for, for example, a front surface of the display. In addition, the above-described configurations are preferable for use as a transparent screen.

[Cholesteric Structure]

The dot is formed of a liquid crystal material having a cholesteric structure It is known that the cholesteric structure exhibits selective reflecting properties at a specific wavelength. A center wavelength (reflection peak wavelength) λ of the selective reflection depends on a pitch P (=helical cycle) of a helical structure in the cholesteric structure and complies with an average refractive index n of a cholesteric liquid crystal and a relationship of λ=n×P. Therefore, the selective reflection wavelength can be adjusted by adjusting the pitch of the helical structure. The pitch of the cholesteric structure depends on the kind of a chiral agent which is used in combination of a liquid crystal compound during the formation of the dot, or the concentration of the chiral agent added. Therefore, a desired pitch can be obtained by adjusting the kind and concentration of the chiral agent.

In addition, selectively reflected light of the cholesteric structure has circularly polarized light selectivity, and selectively reflected light of the cholesteric structure is right circularly polarized light or left circularly polarized light. Whether or not the reflected light of the cholesteric structure is right circularly polarized light or left circularly polarized light is determined depending on a helical twisting direction of the cholesteric structure. In a case where the helical twisting direction of the cholesteric structure is right, right circularly polarized light is reflected, and in a case where the helical twisting direction of the cholesteric structure is left, left circularly polarized light is reflected.

The details of the adjustment of the pitch can be found in “Fuji Film Research&Development” No. 50 (2005), pp. 60 to 63. As a method of measuring a helical twisting direction or a pitch, a method described in “Introduction to Experimental Liquid Crystal Chemistry”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

The cholesteric structure is observed as a stripe pattern including bright portions and dark portions when observed with a scanning electron microscope (SEM). Two cycles of the bright portion and the dark portion (two bright portions and two dark portions) correspond to one helical pitch. Therefore, the pitch can be measured from the SEM cross-sectional view. A normal line perpendicular to each line of the stripe pattern is a helical axis direction.

A full width at half maximum Δλ (nm) of a selective reflection bandwidth (circularly polarized light reflection bandwidth) where selective reflection is exhibited depends on a birefringence An of the liquid crystal compound and the pitch P and complies with a relationship of Δλ=Δn×P. Therefore, the selective reflection bandwidth can be controlled by adjusting Δn. Δn can be adjusted by adjusting the kind of the polymerizable liquid crystal compound and a mixing ratio thereof, or by controlling a temperature during oriented immobilization. The full width at half maximum of the reflection wavelength range is adjusted depending on the application of the optical member according to the present invention and is, for example, 50 to 500 nm and preferably 100 to 300 nm.

[Cholesteric Structure in Dot]

It is preferable that, in the dot, an angle between a helical axis of the cholesteric structure and a surface of the dot is in a range of 50° to 90°. The angle is more preferably in a range of 60° to 90° and still more preferably in a range of 70° to 90°. It is more preferable that, on a surface of the dot, an angle between a helical axis of the cholesteric structure and the surface of the dot is in a range of 70° to 90°.

The helical axis of the cholesteric structure is present in a normal direction perpendicular to a line formed using each dark portion when a cross-section of the dot is observed with a scanning electron microscope (SEM). An angle between the helical axis of the cholesteric structure and a surface of the dot refers to an angle between it is preferable that an angle between a normal line perpendicular to a line, which is formed using a first dark portion from the surface of the dot, and the surface of the dot. When the surface is curved, an angle between the normal line and a tangent line of the surface in the cross-section may be obtained. In particular, by satisfying the angle in the inclined portion or the curved portion, the dot can also exhibit high retroreflection properties with respect to light incident from various directions with an angle from the normal direction perpendicular to the substrate. For example, even in a configuration where the optical member according to the present invention does not include an overcoat layer, the dot can exhibit high retroreflection properties with respect to light incident from a direction with a polar angle of 5° and with respect to light incident from a direction with a polar angle of 30°.

In particular, it is preferable that an angle between the helical axis of the cholesteric structure and a surface of a part of the inclined portion or the curved portion satisfies a range of 70° to 90°. For example, it is preferable that the angle satisfies the above-described range not intermittently but continuously in a part of the inclined portion or the curved portion. In addition, the angle is expressed by an acute angle, and, for example, the angle range of 70° to 90° refers to a range of 70° to 110° when the angle between the normal line and the surface expressed by an angle of 0° to 180°. In the cross-sectional view; it is preferable that an angle between a normal line perpendicular to each of lines, which are formed using first and second dark portions from a surface of the dot, and the surface is in a range of 70° to 90°, it is more preferable that an angle between a normal line perpendicular to each of lines, which are formed using first to third or fourth dark portions from a surface of the dot, and the surface is in a range of 70° to 90°, and it is still more preferable that an angle between a normal line perpendicular to each of lines, which are formed using first to fifth to twelfth or more dark portions from a surface of the dot, and the surface is in a range of 70° to 90°.

On a surface of the dot, an angle between the helical axis of the cholesteric structure and the surface of the dot is preferably in a range of 0° to 90° and more preferably in a range of 85° to 90°.

The cholesteric structure can be obtained by immobilizing a cholesteric liquid crystal phase. The structure in which a cholesteric liquid crystal phase is immobilized may be a structure in which the orientation of the liquid crystal compound as a cholesteric liquid crystal phase is immobilized. Typically, the structure in which a cholesteric liquid crystal phase is immobilized may be a structure which is obtained by making the polymerizable liquid crystal compound to be in a state where a cholesteric liquid crystal phase is oriented, polymerizing and curing the polymerizable liquid crystal compound with ultraviolet irradiation, heating, or the like to form a layer having no fluidity, and concurrently changing the state of the polymerizable liquid crystal compound into a state where the oriented state is not changed by an external field or an external three. The structure in which a cholesteric liquid crystal phase is immobilized is not particularly limited as long as the optical characteristics of the cholesteric liquid crystal phase are maintained, and the liquid crystal compound does not necessarily exhibit liquid crystallinity. For example, the molecular weight of the polymerizable liquid crystal compound may be increased by a curing reaction such that the liquid crystallinity thereof is lost.

[Method of Forming Dot]

The dot can be formed, for example, by applying a liquid crystal composition described below to the liquid crystal layer surface of the substrate, drying the liquid crystal composition, and optionally curing the liquid crystal composition. The surface of the liquid crystal layer may be treated before the formation of the dot. For example, in order to form a dot having a desired shape or to form a desired dot pattern, a hydrophilic treatment or a treatment for forming an uneven shape may be performed on the surface of the substrate.

(Jetting of Liquid Crystal Composition)

The application of the liquid crystal composition to the substrate for forming the dot is preferably performed by jetting. In a case where a plurality of dots are formed on the substrate, the liquid crystal composition may be printed as an ink. A printing method is not particularly limited and, for example, an ink jet method, a gravure printing method, or a flexographic printing method can be used. Among these, an ink jet method is preferable. The pattern of the dots can also be formed using a well-known printing technique.

(Drying of Liquid Crystal. Composition)

The liquid crystal composition applied to the surface of the substrate is optionally dried. The liquid crystal composition may be heated for drying or may be dried and then heated. In a drying or heating step, the liquid crystal compound in the liquid crystal composition only has to be oriented to form a cholesteric liquid crystal phase. In the case of heating, the heating temperature is preferably 200° C. or lower and more preferably 130° C. or lower.

(Curing of Liquid Crystal Composition)

In a case where the liquid crystal composition is a polymerizable liquid crystal compound, the oriented polymerizable liquid crystal compound may be polymerized by curing the liquid crystal composition. The liquid crystal composition may be cured by light irradiation or heating and preferably by light irradiation. Regarding the light irradiation, ultraviolet light is preferably used. The irradiation energy is preferably 20 mJ/cm² to 50 mJ/cm² and more preferably 100 mJ/cm² to 1500 mJ/cm². In order to promote a photopolymerization reaction, light irradiation may be performed under heating conditions or in a nitrogen atmosphere. The wavelength of irradiated ultraviolet light is preferably 250 nm to 430 nm. From the viewpoint of stability, the polymerization degree is preferably high, and is preferably 70% or higher and more preferably 80% or higher. The polymerization degree can be determined by obtaining a consumption ratio between polymerizable functional groups using an IR absorption spectrum.

<Liquid Crystal Composition>

Hereinafter, the liquid crystal composition as a material which can be used for forming the liquid crystal layer and for forming the dot (cholesteric structure) will be described.

The liquid crystal composition includes a liquid crystal compound. It is preferable that the liquid crystal compound is a polymerizable liquid crystal compound. In addition, the liquid crystal composition may further include, for example, a surfactant or a polymerization initiator. It is preferable that the liquid crystal composition used for forming the dot includes a chiral agent.

[Polymerizable Liquid Crystal Compound]

The polymerizable liquid crystal compound may be a rod-shaped liquid crystal compound or a disk-shaped liquid crystal compound and is preferably a rod-shaped liquid crystal compound.

Examples of the rod-shaped polymerizable liquid crystal compound for forming a cholesteric liquid crystal layer include a rod-shaped nematic liquid crystal compound. As the rod-shaped nematic liquid crystal compound, an azomethine compound, an azoxy compound, a cyanophenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. Not only a low-molecular-weight liquid crystal compound but also a high-molecular-weight liquid crystal compound can be used.

The polymerizable liquid crystal compound can be obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups in the polymerizable liquid crystal compound is preferably 1 to 6 and more preferably 1 to 3. Examples of the polymerizable liquid crystal compound include compounds described in Makromol. Chem. (1989), Vol. 190, p. 2255, Advanced. Materials (1993), Vol. 5, p. 107, U.S. Pat. No. 4,683,327A, U.S. Pat. No. 5,622,648A, U.S. Pat. No. 5,770,107A, WO95/22586, WO95/24455, WO97/00600, WO98/23580, WO98/52905, JP1989-272551A (JP-H1-272551A), JP1994-16616A (JP-H6-16616A), JP1995-110469A (JP-H7-110469A), JP1999-80081A (JP-H11-80081A), JP2001-328973A, JP2014-198815A, and JP2014-198814A. Two or more polymerizable liquid crystal compounds may be used in combination. In a case where two or more polymerizable liquid crystal compounds are used in combination, the orientation temperature can be decreased.

Specific examples of the polymerizable liquid crystal compound include a compound represented by any one of the following formulae (1) to (11).

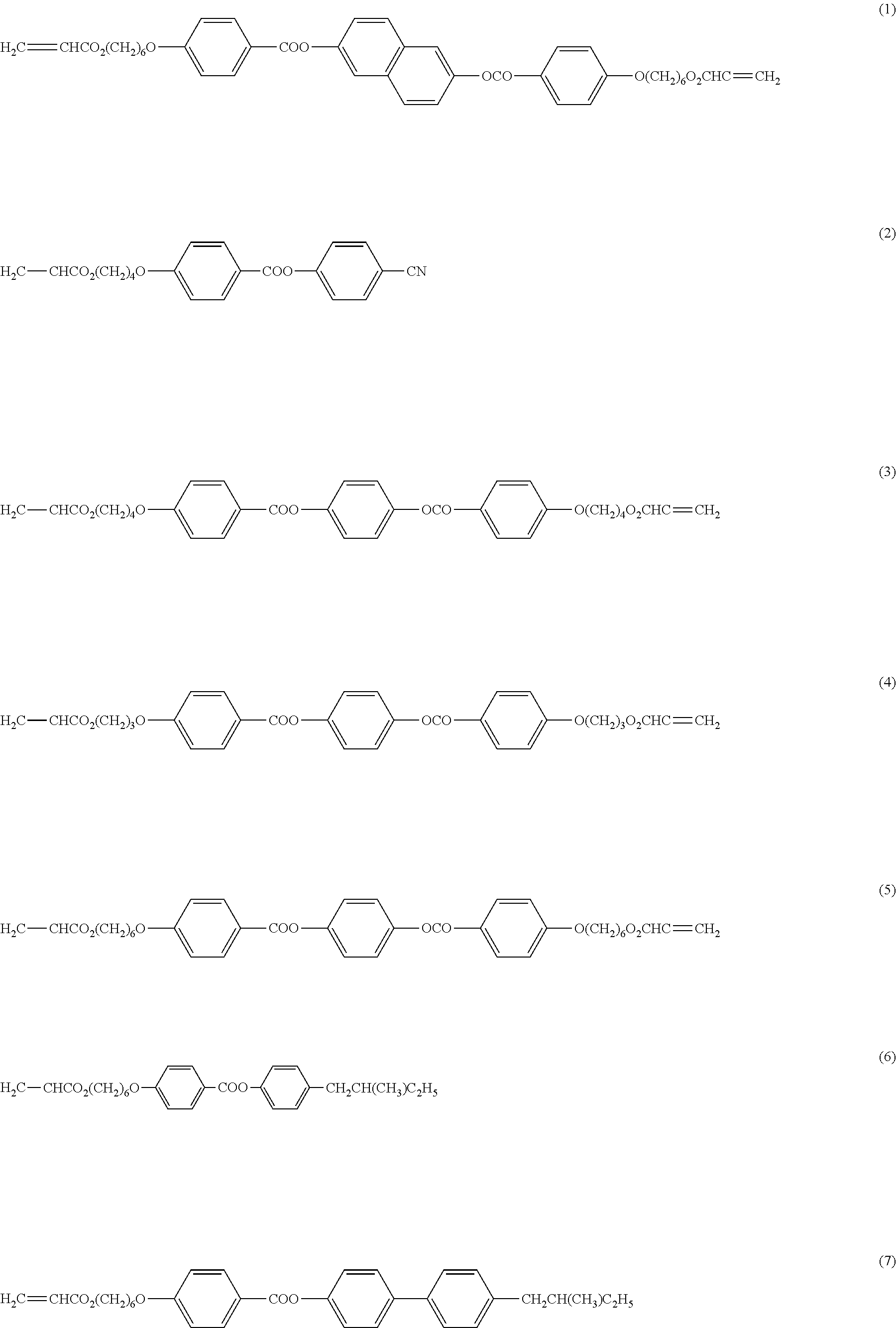

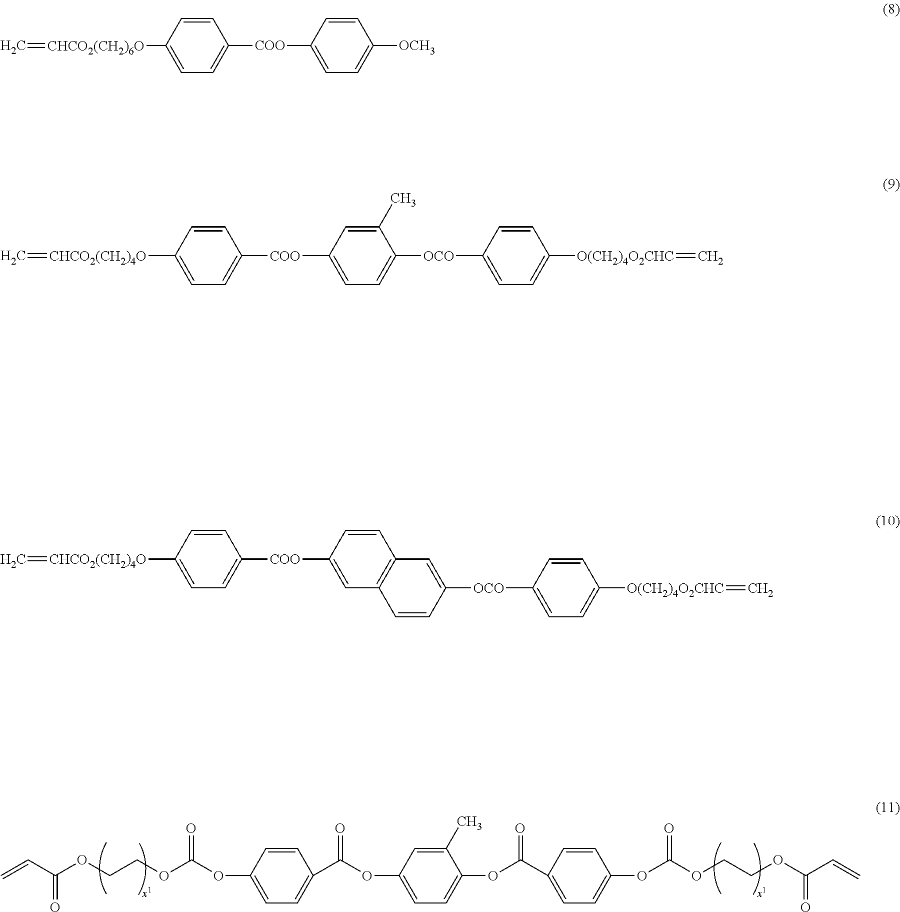

(In compound (11), X¹ represents 2 to 5 (integer))

In addition, as a polymerizable liquid crystal compound other than the above-described examples, for example, a cyclic organopolysiloxane compound having a cholesteric phase described in JP1982-165480A (JP-S57-165480A) can be used. Further, as the above-described high-molecular-weight liquid crystal compound, for example, a polymer in which a liquid crystal mesogenic group is introduced into a main chain, a side chain, or both a main chain and a side chain, a polymer cholesteric liquid crystal in which a cholesteryl group is introduced into a side chain, a liquid crystal polymer described in JP1997-133810A (JP-H9-133810A), and a liquid crystal polymer described in JP1999-293252A (JP-H11-293252A) can be used.

In addition, the addition amount of the polymerizable liquid crystal compound in the liquid crystal composition is preferably 75 to 99.9 mass %, more preferably 80 to 99 mass %, and still more preferably 85 to 90 mass % with respect to the solid content mass (mass excluding a solvent) of the liquid crystal composition.

[Chiral Agent (Optically Active Compound)]

It is preferable that the liquid crystal composition used for forming the dot includes a chiral agent. The chiral agent has a function of causing a helical structure of a cholesteric liquid crystal phase to be formed. The chiral compound may be selected depending on the purpose because a helical twisting direction or a helical pitch derived from the compound varies.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for TN or STN, p. 199), isosorbide, or an isomannide derivative can be used.

In general, the chiral agent includes an asymmetric carbon atom. However, an axially asymmetric compound or a surface asymmetric compound not having an asymmetric carbon atom can be used. Examples of the axially asymmetric compound or the surface asymmetric compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this configuration, it is preferable that the polymerizable group included in the polymerizable chiral agent is the same as the polymerizable group included in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

Specific examples of the chiral agent include a compound represented by the following Formula (12).

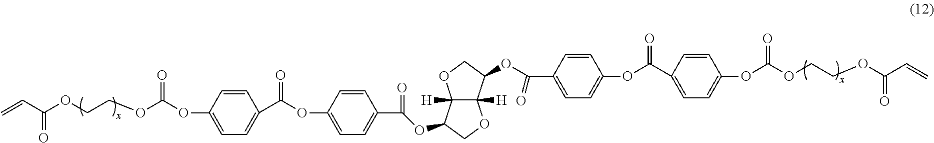

In the formula, X represents 2 to 5 (integer).

The content of the chiral agent in the liquid crystal composition is preferably 0.01 mol % to 200 mol % and more preferably 1 mol % to 30 mol % with respect to the amount of the polymerizable liquid crystal compound.

[Surfactant]

It is preferable that the liquid crystal composition includes a surfactant, Examples of the surfactant include a silicone surfactant and a fluorine surfactant. Among these, a fluorine surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and “0082” to “0085” of JP2002-129162A, and fluorine (meth)acrylate polymers described in paragraphs “0018” to “0043” of JP2007-272185A.

As the surfactant, one kind may be used alone, or two or more kinds may be used in combination.

Examples of the fluorine surfactant include a compound represented by the following Formula (I) described in paragraphs “0082” to “0090” of JP2014-119605A.

(Hb¹¹-Sp¹¹-L¹¹-Sp¹²-L¹²)ₘ₁₁-A¹¹L¹³-T¹¹-L¹⁴-A¹²-(L¹⁵-Sp¹³-L¹⁶-Sp¹⁴-Hb¹¹)ₙ₁₁ Formula (1)

In Formula (I), L¹¹, L¹², L¹³, L¹⁴, L¹⁵, and L¹⁶ each independently represent a single bond, —O—, —S—, —CO—, —COO—, —OCO—, —COS—, —SCO—, —NRCO—, or —CONR— (in Formula (I), R represents a hydrogen atom or an alkyl group having 1 to 6 carbon atoms). —NRCO— or —CONR— has an effect of reducing solubility and is likely to increase haze during the preparation of the dot. From this viewpoint, —O—, —S—, —CO—, —COO—, —OCO—, —COS— or —SCO— is more preferable. From the viewpoint of the stability of the compound, —O—, —CO—, —COO—, or —OCO— is more preferable. An alkyl group represented by R may be linear or branched. An alkyl group having 1 to 3 carbon atoms is more preferable, and examples thereof include a methyl group, an ethyl group, and an n-propyl group.

Sp¹¹, Sp¹², Sp¹³, and Sp¹⁴ each independently represent a single bond or an alkylene group having 1 to 10 carbon atoms, more preferably a single bond or an alkylene group having 1 to 7 carbon atoms, and still more preferably a single bond or an alkylene group having 1 to 4 carbon atoms. However, a hydrogen atom in the alkylene group may be substituted with a fluorine atom. The alkylene group may have a branch or not, and a linear alkylene group having no branch is preferable. From the viewpoint of synthesis, it is preferable that Sp¹¹ and Sp¹⁴ are the same and Sp¹² and Sp¹³ are the same.

A¹¹ and A¹² represent a monovalent to tetravalent aromatic hydrocarbon group. The number of carbon atoms in the aromatic hydrocarbon group is preferably 6 to 22, more preferably 6 to 14, still more preferably 6 to 10, and still more preferably 6. The aromatic hydrocarbon group represented by A¹¹ or A¹² may have a substituent. Examples of the substituent include an alkyl group having 1 to 8 carbon atoms, an alkoxy group, a halogen atom, a cyano group, and an ester group. The description and preferable ranges of the groups can be found in the corresponding description of T described below. Examples of a substituent with which the aromatic hydrocarbon group represented by A¹¹ or A¹² is substituted include a methyl group, an ethyl group, a methoxy group, an ethoxy group, a bromine atom, a chlorine atom, and a cyano group. A molecule including a large amount of a perfluoroalkyl portion can cause liquid crystal to be oriented even in a small addition amount, which leads to reduction in haze. Therefore, in order for the molecule to include many perfluoroalkyl groups, it is preferable that A¹¹ and A¹² are tetravalent. From the viewpoint of synthesis, it is preferable that A¹¹ and A¹² are the same.

T¹¹ represents a divalent group or a divalent aromatic heterocyclic group preferably represented by any one of the following formulae (X in T¹¹ represents an alkyl group having 1 to 8 carbon atoms, an alkoxy group, a halogen atom, a cyano group, or an ester group, and Ya, Yb, Yc, and Yd each independently represent a hydrogen atom or an alkyl group having 1 to 4 carbon atoms).

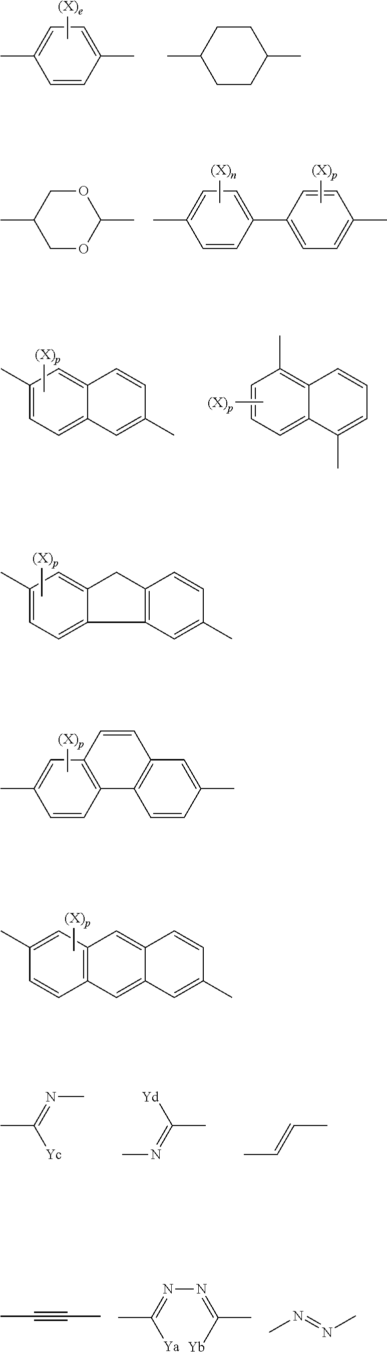

more preferably represented by any one of the following formulae,

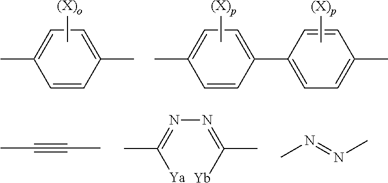

still more preferably represented by the following formula.

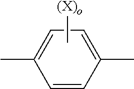

The number of carbon atoms in the alkyl group represented by X in T¹¹ is 1 to 8, preferably 1 to 5, and more preferably 1 to 3. The alkylene group may be linear, branched, or cyclic and is preferably linear or branched. Preferable examples of the alkyl group include a methyl group, an ethyl group, an n-propyl group, and an isopropyl group. Among these, a methyl group is preferable. The details of an alkyl portion of the alkoxy group represented by X in T¹¹ can be found in the description and preferable range of the alkyl group represented by X in T¹¹. Examples of the halogen atom represented by X in T¹¹ include a fluorine atom, a chlorine atom, a bromine atom, and an iodine atom. Among these, a chlorine atom or a bromine atom is preferable. Examples of the ester group represented by X in T¹¹ include a group represented by R′COO—. R′ represents, for example, an alkyl group having 1 to 8 carbon atoms. The description and preferable range of the alkyl group represented by R′ can be found in the description and preferable range of the alkyl group represented by X in T¹¹. Specific examples of the ester include CH₃COO— and C₂H₅COO—. The alkyl group having 1 to 4 carbon atoms represented by Ya, Yb, Yc, or Yd may be linear or branched. Examples of the alkyl group having 1 to 4 carbon atoms include a methyl group, an ethyl group, an n-propyl group, and an isopropyl group.

It is preferable that the divalent aromatic heterocyclic group has a 5-membered, 6-membered, or 7-membered heterocycle. A 5-membered or 6-membered heterocycle is more preferable, and a 6-membered heterocycle is most preferable. As a heteroatom constituting the heterocycle, a nitrogen atom, an oxygen atom, or a sulfur atom is preferable. It is preferable that the heterocycle is an aromatic heterocycle. In general, the aromatic heterocycle is an unsaturated heterocycle. An unsaturated heterocycle having most double bonds is more preferable. Examples of the heterocycle include a furan ring, a thiophene ring, a pyrrole ring, a pyrroline ring, a pyrrolidine ring, an oxazole ring, an isoxazole ring, a thiazole ring, an isothiazole ring, an imidazole ring, an imidazoline ring, an imidazolidine ring, a pyrazole ring, a pyrazoline ring, a pyrazolidine ring, a triazole ring, a furazan ring, a tetrazole ring, a pyran ring, a thiin ring, a pyridine ring, a piperidine ring, an oxazine ring, a morpholine ring, a thiazine ring, a pyridazine ring, a pyrimidine ring, a pyrazine ring, a piperazine ring, and a triazine ring. The divalent heterocyclic group may have a substituent. The description and preferable range of the substituent can be found in the description of the substituent with which the monovalent to tetravalent aromatic hydrocarbon represented by A¹ or A² is substituted.

Hb¹¹ represents a perfluoroalkyl group having 2 to 30 carbon atoms, more preferably a perfluoroalkyl group having 3 to 20 carbon atoms, and still more preferably a perfluoroalkyl group having 3 to 10 carbon atoms. The perfluoroalkyl group may be linear, branched, or cyclic and is preferably linear or branched and more preferably linear.

m11 and n11 each independently represent 0 to 3 and m11+n11≧1. At this time, a plurality of structures in parentheses may be the same as or different from each other and is preferably the same as each other. m11 and nil in Formula (I) are determined depending on the valences of A¹¹ and A¹², and preferable ranges thereof are determined depending on the preferable ranges of the valences and A¹².

o and p in T¹¹ each independently represent an integer of 0 or more. In a case where o and p represent an integer of 2 or more, a plurality of X's may be the same as or different from each other. o in T¹¹ represents preferably 1 or 2. p in T¹¹ represents preferably an integer of 1 to 4 and more preferably 1 to 2.

A molecular structure of the compound represented by Formula (I) may be symmetrical or non-symmetrical. “Symmetry” described herein represents at least one of point symmetry, line symmetry; or rotational symmetry, and “non-symmetry” described herein does not represent any one of point symmetry, line symmetry, and rotational symmetry.

The compound represented by Formula (I) is a combination of the perfluoroalkyl group (Hb¹¹), the linking groups -(-Sp¹¹-L¹¹-Sp¹²-L¹²)m₁₁-A¹¹-L¹³- and -L¹⁴-A¹²-(L¹⁵-Sp¹³-L¹⁶-Sp¹⁴)ₙ₁₁-, and preferably the divalent group having an excluded volume effect which is represented by T. Two perfluoroalkyl groups (Hb¹¹) present in the molecule are preferably the same as each other, and the linking groups -(-Sp¹¹-L¹¹-Sp¹²-L¹²)m₁₁-A¹¹-L¹³- and -L¹⁴-A¹²-(L¹⁵-Sp¹³-L¹⁶-Sp¹⁴)ₙ₁₁- present in the molecule are also preferably the same as each other. Hb¹¹-Sp¹¹-L¹¹-Sp¹²- and -Sp13-L¹⁶-Sp¹⁴-Hb¹¹ present at the terminal are preferably a group represented by any one of the following formulae:

(CₐF₂ₐ₊₁)—(C_{b}H_{2b})—;

(CₐF₂ₐ₊₁)—(C_{b}H_{2b})—O—(CᵣH₂ᵣ;

(CₐF₂ₐ₊₁)—(C_{b}H_{2b})—COO—(CᵣH₂ᵣ)—; and

(CₐF₂ₐ₊₁)—(C_{b}H_{2b})—OCO—(CᵣH₂ᵣ)—.

In the above formulae, a represents preferably 2 to 30, more preferably 3 to 20, and still more preferably 3 to 10. h represents preferably 0 to 20, more preferably 0 to 10, and still more preferably 0 to 5. a+-b represents 3 to 30. r represents preferably 1 to 1.0 and more preferably 1 to 4.

In addition, Hb¹¹-Sp¹¹-L¹¹-Sp¹²-L¹² and -L¹⁵-Sp¹³-L¹⁶-Sp¹⁴-Hb¹¹ present at the terminal of Formula (I) are preferably a group represented by any one of the following formulae:

(CₐF₂ₐ₊₁)—(C_{b}H_{2b})—O—;

(CₐF₂ₐ₊)—(C_{b}H_{2b})—COO—;

(CₐF₂ₐ₊₁)—(C_{b}H_{2b})—O—(ᵣH₂ᵣ)—O—;

(CₐF₂ₐ₊₁)—(C_{b}H_{2b})—COO—(CᵣH₂ᵣ)—COO—; and

(CₐF₂ₐ₊₁)—(C_{b}H_{2b})—OCO—(CᵣH₂ᵣ)—COO—.

In the above formulae, a, b, and r have the same definitions as described above.

In particular, it is preferable that the surfactant for forming the liquid crystal layer can cause the orientation of liquid crystals to be horizontally aligned and can impart required liquid repellency. The structure of the surfactant is not particularly limited as long as it satisfies the above requirements. As the surfactant for forming the liquid crystal layer, for example, a low-molecular-weight surfactant or a copolymer surfactant is preferably used.

The low-molecular-weight surfactant is a compound having at least six perfluoroalkyl groups represented by (CₐF₂ₐ₊₁) in the molecule. a represents preferably 4 or more and more preferably 6 or more. Specifically, for example, compounds described in JP2013-47204A and JP2002-129162A can be preferably used.

The copolymer surfactant is a copolymer which is formed of a monomer containing a perfluoroalkyl group represented by the following structure, in which a ratio of the mass of the monomer represented by the following structure to the total mass of all the monomers is 25% or higher. The mass ratio of the monomer is preferably 30% or higher and more preferably 35% or higher. In addition, a in the formula represents preferably 4 or more and more preferably 6 or more. a2 in the formula represents an integer of 1 to 3 and preferably 2. R represents a methyl group or hydrogen and preferably hydrogen.

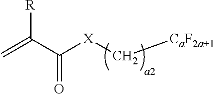

Specifically, for example, copolymers described in JP2008-257205A or JP2004-198511A can be preferably used.

The addition amount of the surfactant in the liquid crystal composition is preferably 0.01 mass % to 10 mass %, more preferably 0.01 mass % to 5 mass %, and still more preferably 0.02 mass % to 1 mass % with respect to the total mass of the polymerizable liquid crystal compound.

In particular, in order to impart liquid repellency, it is preferable that the addition amount of the surfactant in the liquid crystal composition for forming the liquid crystal layer is more than the minimum amount required for the horizontal alignment of liquid crystals. Specifically, the addition amount of the surfactant in the liquid crystal composition is preferably 0.2 mass % or higher, more preferably 0.3 mass % or higher, and still more preferably 0.4 mass % or higher with respect to the total mass of the polymerizable liquid crystal compound.

[Polymerization Initiator]

In a case where the liquid crystal composition includes a polymerizable compound, it is preferable that the liquid crystal composition includes a polymerization initiator. In a configuration where a polymerization reaction progresses with ultraviolet irradiation, it is preferable that the polymerization initiator is a photopolymerization initiator which initiates a polymerization reaction with ultraviolet irradiation. Examples of the photopolymerization initiator include an α-carbonyl compound (described in U.S. Pat. No. 2,367,661A and U.S. Pat. No. 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. No. 3,046,127A and U.S. Pat. No. 2,951,758A), a combination of a triaryl imidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of the photopolymerization initiator in the liquid crystal composition is preferably 0.1 to 20 mass % and more preferably 0.5 mass % to 12 mass % with respect to the content of the polymerizable liquid crystal compound.

[Crosslinking Agent]

In order to improve the film hardness after curing and to improve durability, the liquid crystal composition may arbitrarily include a crosslinking agent. As the crosslinking agent, a curing agent which can perform curing with ultraviolet light, heat, moisture, or the like can be preferably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an aziridine compound such as 2,2-bis hydroxymethyl butanol-tris[3-(1-aziridinyl)propionate] or 4,4-bis(ethyleneiminocarbonylamino)diphenylmethane; an isocyanate compound such as hexamethylene diisocyanate or a biuret type isocyanate; a polyoxazoline compound having an oxazoline group at a side chain thereof; and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. Among these curing agents, one kind may be used alone, or two or more kinds may be used in combination.

The content of the crosslinking agent is preferably 3 mass % to 20 mass % and more preferably 5 mass % to 15 mass %. In a case where the content of the crosslinking agent is lower than 3 mass %, an effect of improving the crosslinking density may not be obtained. In a case where the content of the crosslinking agent is higher than 20 mass %, the stability of a cholesteric liquid crystal layer may deteriorate.

[Other Additives]

The liquid crystal composition may include a monofunctional polymerizable monomer. In particular, it is preferable that the liquid crystal composition for forming the dot includes a monofunctional polymerizable monomer. The reason for this is that, in a case where an ink jet method described below is used as a dot forming method, generally required ink properties can be obtained by using the monofunctional polymerizable monomer. Examples of the monofunctional polymerizable monomer include 2-methoxyethyl acrylate, isobutyl acrylate, isooctyl acrylate, isodecyl acrylate, and octyl/decyl acrylate.

In addition, optionally, a polymerization inhibitor, an antioxidant, a ultraviolet absorber, a light stabilizer, a colorant, metal oxide particles or the like can be added to the liquid crystal composition in a range where optical performance and the like do not deteriorate.

[Solvent]

The liquid crystal composition may include a solvent. The solvent is not particularly limited and can be appropriately selected depending on the purpose. An organic solvent is preferably used.

The organic solvent is not particularly limited and can be appropriately selected depending on the purpose. Examples of the organic solvent include a ketone such as methyl ethyl ketone or methyl isobutyl ketone, an alkyl halide, an amide, a sulfoxide, a heterocyclic compound, a hydrocarbon, an ester, and an ether. Among these curing agents, one kind may be used alone, or two or more kinds may be used in combination. Among these, a ketone is more preferable in consideration of an environmental burden. The above-described component such as the above-described monofunctional polymerizable monomer may function as the solvent.

<Overcoat Layer>

The optical member may include an overcoat layer. The overcoat layer may be provided on the liquid crystal layer-side substrate where the dot is formed, and it is preferable that the surface of the optical member is smoothened.

The overcoat layer is not particularly limited and is preferably a resin layer having a refractive index of about 1.4 to 1.8. In a case where the optical member is used as an input medium such as an input sheet on a display surface of an image display device or the like, in order to prevent scattering of image light from the image display device, a difference in refractive index between the overcoat layer and the dot formed of the liquid crystal material is preferably 0.2 or lower and more preferably 0.1 or lower. The refractive index of the dot formed of the liquid crystal material is about 1.6. By using an overcoat layer having a refractive index of about 1.4 to 1.8, the polar angle of light which is actually incident on the dot can be reduced. For example, in a case where the overcoat layer having a refractive index of 1.6 is used and light is incident on the optical member at a polar angle of 45°, a polar angle at which light is reliably incident on the dot can be made to be about 27°. Therefore, by using the overcoat layer, the polar angle of light at which the optical member exhibits retroreflection properties can be widened, and high retroreflection properties can be obtained at a wider angle even in the surface of the dot which forms a small angle with the substrate. In addition, the overcoat layer may function as an anti-reflection layer, a pressure sensitive adhesive layer, an adhesive layer, or a hard coat layer.

Examples of the overcoat layer include a resin layer which is obtained by applying a composition including a monomer to the liquid crystal layer-surface of the substrate where the dot is formed, and curing the coating film. The resin is not particularly limited and may be selected in consideration of, for example, adhesiveness with the substrate or the liquid crystal material for forming the dot. For example, a thermoplastic resin, a thermosetting resin, or a ultraviolet curable resin can be used. From the viewpoints of durability, solvent resistance, and the like, a resin which is curable by crosslinking is preferable, and an ultraviolet curable resin which is curable within a short period of time is more preferable. Examples of the monomer which can be used for forming the overcoat layer include ethyl (meth)acrylate, ethylhexyl (meth)acrylate, styrene, methylstyrene, N-vinylpyrrolidone, polymethylol propane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentyl glycol di(meth)acrylate.

The thickness of the overcoat layer may be selected depending on the maximum height of the dot without any particular limitation, and is preferably about 5 μm to 100 μm, more preferably 10 μm to 50 μm, and still more preferably 20 μm to 40 μm. The thickness is the distance from a surface of the substrate, where the dot is formed, to a surface of the overcoat layer provided on a surface of the substrate, where the dot is not formed, which is opposite to the surface where the dot is formed.

<Application of Optical Member>

The application of the optical member according to the present invention is not particularly limited and can be used as various reflection members.

For example, the optical member having a configuration in which a plurality of dots are formed to be adjacent to each other on the surface of the substrate can be used as a retroreflection member which reflects only circularly polarized light at a specific wavelength.

In addition, the optical member according to the present invention can be used as a transparent screen. By adjusting a wavelength range where the dot exhibits selective reflection to match with a wavelength range of image light emitted from an imaging device such as a projector, the image light can be reflected. In the optical member according to the present invention, light in a specific wavelength range is reflected from the dot. Therefore, the image light passes through portions other than the dot, and light in a wavelength range other than the specific wavelength range passes through the dot. Therefore, the optical member according to the present invention can be used as a transparent screen where the image light and the background on a rear surface side can be observed in a state where they overlap each other.

Regarding the optical member where the dots are provided in a pattern shape, for example, by forming the pattern as a dot pattern which is encoded to present position information, the optical member can be used as an input medium which is used in combination with input means such as an electronic pen for converting handwritten information into digital data and inputting the digital data into an information processing device. The optical member is used after preparing the liquid crystal material for forming the dot such that the wavelength of light irradiated from the input means is the same as that where the dot exhibits reflecting properties. Specifically, the helical pitch of the cholesteric structure may be adjusted using the above-described method.

The optical member according to the present invention can also be used as an input medium such as an input sheet on a display screen such as a liquid crystal display. At this time, it is preferable that the optical member is transparent. The optical member may be attached to a display screen directly or with another film interposed therebetween so as to be integrated with a display, or may be detachably mounted on a display screen. At this time, it is preferable that the wavelength range of light where the dot in the optical member according to the present invention exhibits selective reflection is different from that of light emitted from a display. That is, it is preferable that the dot has selective reflecting properties in the invisible range and that the display emits invisible light such that a detecting device does not detect light erroneously.

The details of an handwriting input system for converting handwritten information into digital data and inputting the digital data into an information processing device can be found in, for example, JP2014-67398A, JP2014-98943A, JP2008-165385A, paragraphs “0021” to “0032” of JP2008-108236A, or JP2008-077451A.

Examples of a preferable embodiment of the case where the optical member according to the present invention is used as the sheet which is mounted on or in front of a surface of an image-displayable device include an embodiment described in paragraphs “0024” to “0031” of JP4725417B.

FIG. 2 is a schematic diagram showing a system in which the optical member according to the present invention is used as a sheet which is mounted on or in front of a surface of an image-displayable device.

In FIG. 2, a well-known sensor may be used without any particular limitation as long as it emits infrared light i and can detect reflected light r from the above-described pattern. Examples of a pen type input terminal 106 including a read data processing device 107 include an input terminal described in JP2003-256137A including: a pen point that does not include an ink, graphite, or the like; a complementary metal-oxide semiconductor (CMOS) camera that includes an infrared irradiating portion; a processor, a memory; a communication interface such as a wireless transceiver using a Bluetooth (registered trade name) technique; and a battery.

Regarding the operation of the pen type input terminal 106, for example, the pen point is drawn in contact with a front surface of the optical member 100 according to the present invention, the pen type input terminal 106 detects a writing pressure applied to the pen point, and the CMOS camera operates such that a predetermined range around the pen point is irradiated with infrared light at a predetermined wavelength which is emitted from the infrared irradiating portion and such that the pattern is imaged (for example, the pattern is imaged several ten times to several hundred times per second). In a case where the pen type input terminal 106 includes the read data processing device 107, the imaged pattern is analyzed by the processor such that an input trajectory generated by the movement of the pen point during handwriting is converted into numerical values and data to generate input trajectory data, and the input trajectory is transmitted to an information processing device.

Members such as the processor, the memory, the communication interface such as a wireless transceiver using a Bluetooth (registered trade name) technique, or the battery may be provided outside of the pen type input terminal 106 as the read data processing device 107 as shown in FIG. 2. In this case, the pen type input terminal 106 may be connected to the read data processing device 107 through a cord 108, or may transmit read data wirelessly using an electric wave, infrared light, or the like.

In addition, the input terminal 106 may be a reader described in JP2001-243006A.

The read data processing device 107 which can be used in the present invention is not particularly limited as long as it has a function of calculating position information based on continuous image data read from the input terminal 106 and providing the calculated position information together with time information as generate input trajectory data which can be processed in an information processing device. The read data processing device 107 only has to include the members such as the processor, the memory, the communication interface, and the battery.

In addition, the read data processing device 107 may be embedded in the input terminal 106 as described in JP2003-256137A, or may be embedded in an information processing device including a display device. In addition, the read data processing device 107 may transmit the position information to an information processing device including a display device wirelessly, or may be connected thereto through a cord or the like.

In the information processing device connected to a display device 105, an image displayed on the display device 105 is sequentially updated based on trajectory information transmitted from the read data processing device 107 such that a trajectory which is handwritten by the input terminal 106 is displayed on the display device as if it was drawn on paper by a pen.

<Image Display Device>

An image display device according to the present invention includes the optical member according to the present invention.

It is preferable that the optical member according to the present invention is mounted on or in front of an image display surface of the image display device. For example, in the image display device, the optical member according to the present invention may be disposed between an outermost surface or a front surface protective plate of a display device and a display panel. A preferable embodiment of the image display device can be found in the above description regarding the application of the optical member.

The invention described in this specification also includes a system including the image display device in which the optical member according to the present invention is mounted on or in front of an image display surface.

### EXAMPLES

Hereinafter, the present invention will be described in detail using examples. Materials, reagents, amounts thereof, proportions thereof, operations, and the like shown in the following examples can be appropriately changed as long as they do not depart from the scope of the present invention. Accordingly, the scope of the present invention is not limited to the following examples.

### Example 1

### (Preparation of Liquid Crystal Layer)

A composition shown below was stirred and dissolved in a container held at 25° C. to prepare a liquid crystal layer-forming solution.

### Liquid Crystal Layer-Forming Solution (Part(S) by Mass)

A rod-shaped liquid crystal composition shown below: 100.0

A surfactant A having the following structure: 0.6

IRGACURE 819 (manufactured by BASF SE): 3.0

Methyl ethyl ketone: 900.0

Rod-Shaped Liquid Crystal Compound

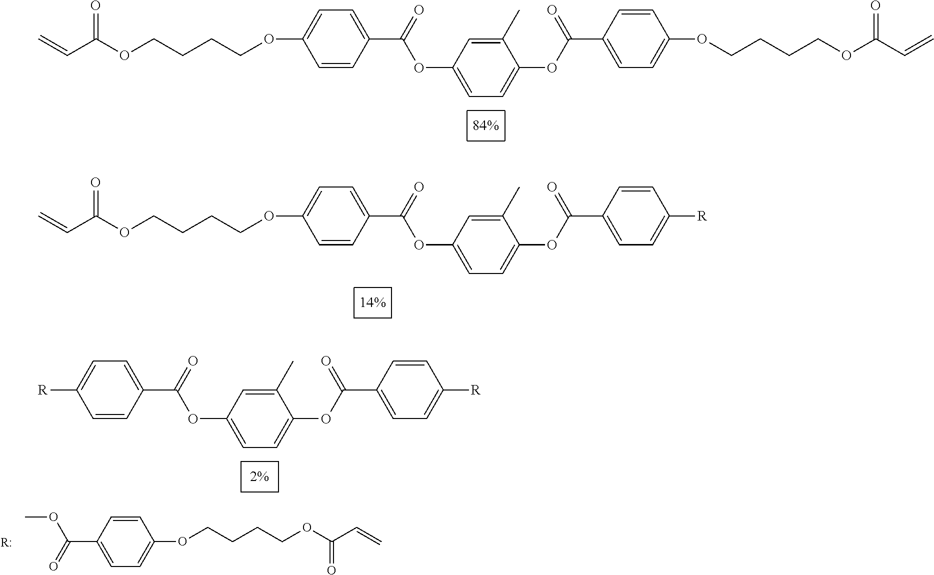

Numerical values are represented by mass %. In addition, a group represented by
R represents a partial structure positioned on the lower right, and an oxygen atom of the partial structure is a bonding site.

Surfactant A

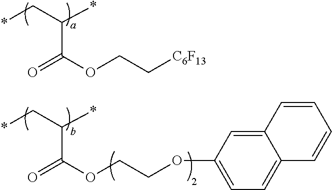

In the formula, a represents 36.5, b represents 63.5, and the surfactant A is a polymer obtained by random copolymerization at this mass ratio.

Next, a polyimide, alignment film SE-130 (manufactured by Nissan Industries Ltd.) was applied to a washed surface of a glass substrate using a spin coating method, was dried, and then was fired at 250° C. for 1 hour. Next, the surface was rubbed. As a result, a support with the alignment film was prepared. The liquid crystal layer forming solution prepared as described above was applied to the rubbed surface of the alignment film using a spin coating method at a rotation speed of 2000 rpm, was oriented and matured at 80° C. for 30 seconds, and was irradiated with 500 mJ/cm² of ultraviolet light at 30° C. using a high pressure mercury lamp in which a short-wavelength component of ultraviolet light was blocked. As a result, a liquid crystal layer in which the oriented state was fixed was obtained.

(Formation of Cholesteric Liquid Crystal Dot)

A composition shown below was stirred and dissolved in a container held at 25° C. to prepare a cholesteric liquid crystal ink solution (liquid crystal composition).

### Cholesteric Liquid Crystal Ink Solution (Part(s) by Mass)

Methoxyethyl acrylate: 150.0

A mixture of rod-shaped liquid crystal compounds having the following structures: 100.0

IRGACURE 819 (manufactured by BASF SE): 10.0

A chiral agent having the following structure: 5.5

A surfactant having the following structure: 0.08

Rod-Shaped Liquid Crystal Compound

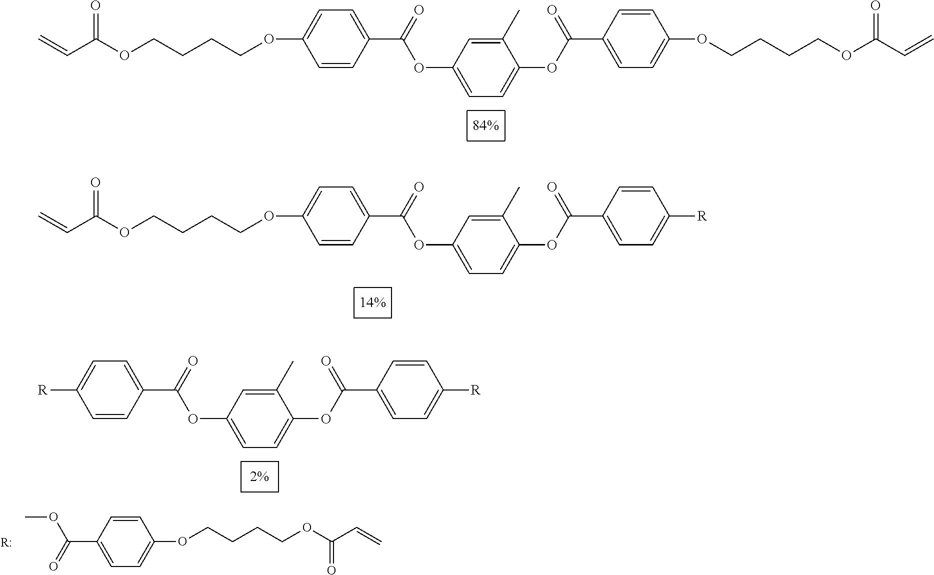

Numerical values are represented by mass %. In addition, a group represented by R is a partial structure present on the left and right sides, and this partial structure is bonded to an oxygen atom portion.

Chiral Agent

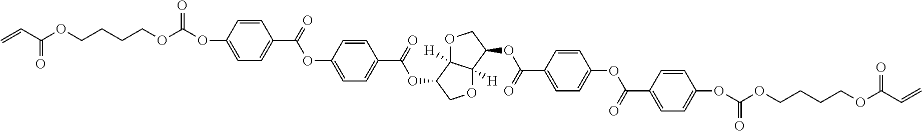 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

Surfactant

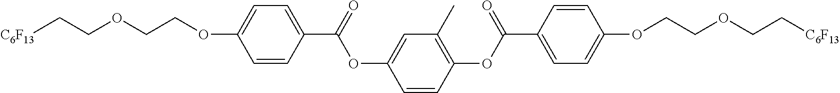

The cholesteric liquid crystal ink solution prepared as described above was applied to the entire 50×50 mm region of the liquid crystal layer of the glass substrate prepared as described above using an ink jet printer (DMP-2831, manufactured by Fujifilm Dimatix Inc.) such that the distance between dot centers was 75 μm. Next, the cholesteric liquid crystal ink solution was dried at 95° C. for 30 seconds and was irradiated with 500 mJ/cm² of ultraviolet light using an ultraviolet irradiation device. As a result, an optical member was obtained.

(Dot Shape and Evaluation of Cholesteric Structure)

Among the dots of the optical member obtained as described above, 10 dots were selected arbitrarily, and the shapes of the dots were observed using a laser microscope (manufactured by Keyence Corporation). The average diameter of the dots was 22 μm, the average maximum height was 6.2 μm, and the height was continuously increased in a direction from the dot end portion to the center.

(Evaluation of Dot Performance)

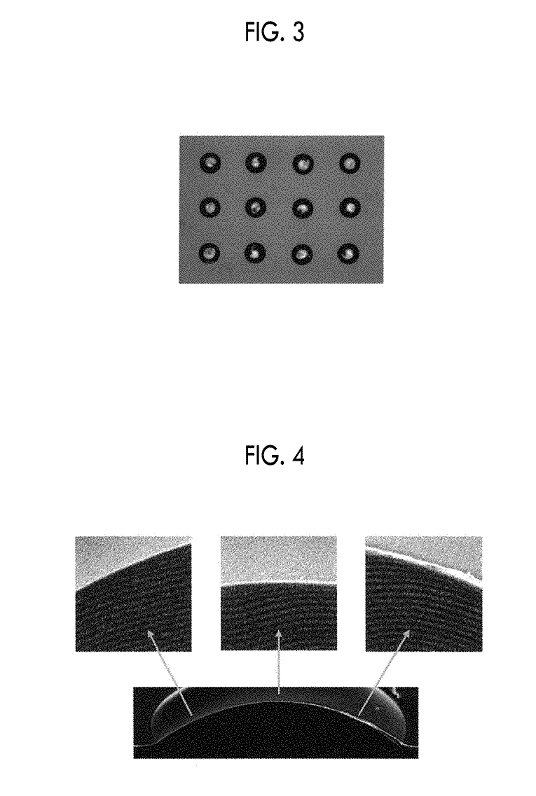

Using an visible and near-infrared light source (HL-2000, manufactured by Ocean Optics Inc.), a ultra high-resolution multi-channel fiber spectrophotometer (HR4000), and a 2-branched optical fiber, the wavelength selective reflecting properties of the optical member were measured in 5 arbitrary visual fields having a diameter of 2 mm. In all the visual fields, the reflection peak wavelengths were 560 nm, and all the dots constantly exhibited retroreflection properties at polar angles of 5° and 30° in a case where the normal line perpendicular to the optical member was set as 0°. FIG. 3 shows a measured image of the optical member at a polar angle of 5°.

### Example 2

An optical member was prepared using the same method as in Example 1, except that the surfactant in the liquid crystal layer forming solution according to Example 1 was changed to a surfactant B having the following structure and the addition amount thereof was changed from 0.6 to 0.3.

Surfactant B

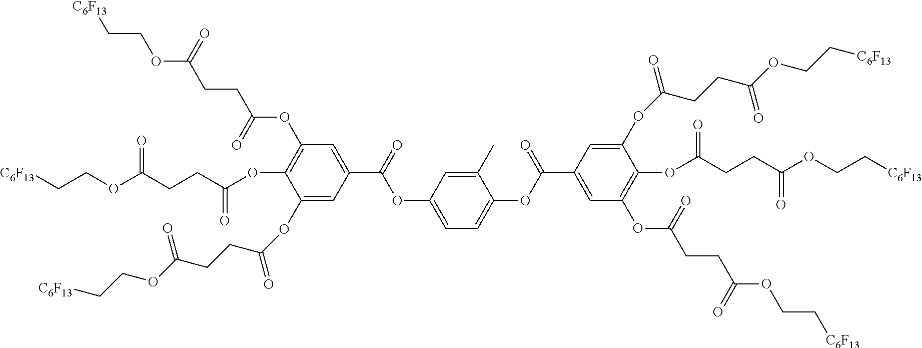

### Example 3

A polyethylene terephthalate film (PET; manufactured by Toyobo Co., Ltd.) having a thickness of 75 μm was rubbed. Next, the liquid crystal layer forming solution according to Example 1 was applied to the rubbed surface using a bar coater such that a wet film thickness was 4 μm, was dried and matured at 85° C. for 1 minute, and was irradiated with 500 mJ/cm² of ultraviolet light at 30° C. using a high pressure mercury lamp in which a short-wavelength component of ultraviolet light was blocked. As a result, a liquid crystal layer in which the oriented state was fixed was obtained. The subsequent steps were performed using the same method as in Example 1 to prepare an optical member.

(Dot Shape and Evaluation of Cholesteric Structure)

Using the same method as in Example 1, among the dots of the optical member obtained as described above, 10 dots were selected arbitrarily, and the shapes of the dots were observed using a laser microscope (manufactured by Keyence Corporation). The height was continuously increased in a direction from the dot end portion to the center.

In addition, regarding one dot positioned at the center of the obtained optical member, a surface including the dot center was cut in a direction perpendicular to the PET substrate, and the obtained cross-section was observed using the above-described scanning electron microscope. As a result, a stripe pattern including bright portions and dark portions was observed in the dot, and a cross-sectional view shown in FIG. 4 was obtained.

In the cross-sectional view, an angle between a normal direction perpendicular to a line, which was formed using a first dark portion from an air interface-side surface of the dot, and the air interface-side surface was measured. As a result, it was found that an angle between the helical axis of the cholesteric structure (the normal direction perpendicular to the like formed using the dark portion) and the dot surface was in a range of 70° to 90°.

### Example 4

An optical member was prepared using the same method as in Example 1, except that a liquid crystal layer was formed using the liquid crystal layer coating solution according to Example 2 and the method according to Example 3.

### Example 5

### (Formation of Alignment Layer)

### Alignment Layer-Forming Coating Solution. (Part(S) by Mass)

Polyvinyl alcohol PVA 103 (manufactured by Kuraray Co., Ltd.): 11.0

Water: 371.0

Methanol: 119.0

The alignment layer-forming coating solution was applied to a triacetyl cellulose film (TAC, manufactured by Fuji Film Co., Ltd.) having a thickness of 80 μm, was dried to remove the solvent under conditions 100° C. and 2 minutes, and then was rubbed. As a result, a substrate with the alignment film was prepared.

Next, a liquid crystal layer was formed using the liquid crystal layer-forming solution according to Example 1 and the method according to Example 3. The subsequent steps were performed using the same method as in Example 1 to prepare an optical member.

Regarding the dots of the obtained optical member, the average diameter was 26 μm, and the average maximum height was 5.9 μm.

### Example 6

A liquid crystal layer was formed on the TAC substrate using the same method as in Example 5, except that the liquid crystal layer-forming solution according to Example 2 was used. The subsequent steps were performed using the same method as in Example 1 to prepare an optical member.

Regarding the dots of the obtained optical member, the average diameter was 35 μm, and the average maximum height was 4.7 μm.

### Comparative Example 1

An optical member was prepared using the same method as in Example 1, except that: the substrate was changed to glass not including the alignment film; and the liquid crystal layer was also not formed.

### Comparative Example 2

An optical member was prepared using the same method as in Example 1, except that the liquid crystal layer was not formed on the substrate (only the glass with the alignment film was used).

### Comparative Example 3

An optical member was prepared using the same method as in Example 3, except that an amorphous layer was formed on the substrate by changing the composition of the liquid crystal layer forming solution to the following composition.

### Amorphous Layer-Forming Solution (Part(S) by Mass)

A-TMMT (manufactured by Shin-Nakamura Chemical Co., Ltd.): 50.0

A surfactant A having the following structure: 0.6

IRGACURE 819 (manufactured by BASF SE): 3.0

Methyl ethyl ketone: 400.0

### Comparative Example 4

An optical member was prepared using the same method as in Example 3, except that the liquid crystal layer was not formed on the substrate (only the rubbed PET was used).

Regarding Examples 2 to 4 and Comparative Examples 1 to 4, the dot diameter, the maximum height/diameter, and whether or not retroreflection was exhibited at polar angles of 5⁰ and 30° in a case where the normal line perpendicular to the optical member was set as 0° were measured using the same method as in Example 1. The results are shown in Table 1.

TABLE 1

| | | | | Dot | | | | |
|---|---|---|---|---|---|---|---|---|
| | | Under layer | | | | | Reflection | Reflection |
| | Substrate | Liquid Crystal Layer | Others | Orientation | Height | Diameter | at 5° | at 30° |
| Example 1 | Glass with Alignment Film | Provided | Surfactant A | Good | 6.2 | 22 | A | A |
| Example 2 | Glass with Alignment Film | Provided | Surfactant B | Good | 4.8 | 36 | A | A |
| Example 3 | Rubbed PET | Provided | Surfactant A | Good | 6.1 | 24 | A | A |
| Example 4 | Rubbed PET | Provided | Surfactant B | Good | 4.5 | 33 | A | A |
| Example 5 | TAC with Alignment Film | Provided | Surfactant A | Good | 5.9 | 26 | A | A |
| Example 6 | TAC with Alignment Film | Provided | Surfactant B | Good | 4.7 | 35 | A | A |
| Comparative Example 1 | Glass | Not provided | None | Poor | 0.7 | 50 | B | B |
| Comparative Example 2 | Glass with Alignment Film | Not provided | None | Good | 0.5 | 75 | B | B |
| Comparative Example 3 | Rubbed PET | Not provided | Amorphous | Poor | 8.1 | 19 | B | A |
| Comparative Example 4 | Rubbed PET | Not provided | None | Good | 1 | 45 | B | B |

Reflection A: Retroreflection was able to be observed
Reflection B: Retroreflection was not able to be observed or was extremely weak

In the samples according to Examples, the cholesteric liquid crystal layer forming the dots was oriented, and retroreflection was able to be observed at all the angles.

In the sample according to Comparative Example 1, the orientation of the cholesteric liquid crystal layer forming the dots was disordered, and the maximum height of the dots was low. Therefore, retroreflection was not able to be observed.

In the samples according to Comparative Examples 2 and 4, the orientation of the cholesteric liquid crystal layer forming the dots was aligned, but the maximum height of the dots was low. Therefore, retroreflection was extremely weak at a polar angle of 5°, and retroreflection was not able to be observed at a polar angle of 30°.

In the sample according to Comparative Example 3, the orientation of the cholesteric liquid crystal layer forming the dots was disordered, and the maximum height of the dots was sufficiently high. Therefore, retroreflection was extremely weak at a polar angle of 5°, and retroreflection was able to be observed at a polar angle of 30°.

### Example 7

### Optical Member Including Overcoat Layer

A composition shown below was stirred and dissolved in a container held at 25° C. to prepare an overcoat layer-forming coating solution.

### Overcoat Layer-Forming Coating Solution (Part(s) by Mass)

Acetone: 100.0

KAYARAD DPCA-30 (manufactured by Nippon Kayaku Co., Ltd.): 100.0

IRGACURE 819 (manufactured by BASF SE): 3.0

The overcoat layer-forming coating solution prepared as described above was applied to the liquid crystal layer, where the cholesteric liquid crystal dot was formed using the method according to Example 1, using a bar coater in an application amount of 40 mL/m². Next, the overcoat layer-forming coating solution was heated such that the film surface temperature was 50° C., and then was dried for 60 seconds. Next, 500 mJ/cm² of ultraviolet light was irradiated using an ultraviolet irradiation device to promote a crosslinking reaction. As a result, an overcoat layer was prepared.

Regarding the optical member including the obtained overcoat layer, dot performance was evaluated.

Using an visible and near-infrared light source (HL-2000, manufactured by Ocean Optics Inc.), a ultra high-resolution multi-channel fiber spectrophotometer (HR4000), and a 2-branched optical fiber, the wavelength selective reflecting properties of the optical member were measured in 5 arbitrary visual fields having a diameter of 2 mm. In all the visual fields, the reflection peak wavelengths were 560 nm, and all the dots constantly exhibited retroreflection properties at polar angles of 5° and 50° in a case where the normal line perpendicular to the optical member was set as 0°.

### Example 8

An optical member was prepared using the same method as in Example 1, except that the addition amount of the chiral agent in the cholesteric liquid crystal ink solution was changed from 5.5 parts by mass to 3.8 parts by mass.

Regarding the dots of the obtained optical member, the average diameter was 23 μm, and the average maximum height was 6.0 μm.

Next, an overcoat layer was formed using the same method as in Example 7, and dot performance was evaluated using the same method as in Example 7. In all the visual fields, the reflection peak wavelengths were 850 nm, and all the dots constantly exhibited retroreflection properties in a polar angle range of 0 to 50 degrees in a case where the normal line perpendicular to the optical member was set as 0 degrees.

### EXPLANATION OF REFERENCES

1: dot

2: substrate

3: support

4: liquid crystal layer

5: overcoat layer

100: optical member

105: display device

106: pen type input terminal

107: read data processing device

108: cord

What is claimed is:

1. An optical member comprising:
a substrate; and
a dot that is in contact with a surface of the substrate,
wherein the dot is formed of a liquid crystal material having a cholesteric structure,
the substrate includes a liquid crystal layer that is formed on the surface in contact with the dot, and
the liquid crystal layer is a layer in which orientation of a liquid crystal compound is immobilized.

2. The optical member according to claim 1,
wherein the liquid crystal layer is a layer in which horizontal alignment of a rod-shaped liquid crystal compound is immobilized.

3. The optical member according to claim 2,
wherein the liquid crystal layer is a cured layer of a composition including a rod-shaped polymerizable liquid crystal compound.

4. The optical member according to claim 1,
wherein the liquid crystal layer includes a surfactant.

5. The optical member according to claim 1,
wherein the substrate includes an alignment film, and
the liquid crystal layer and the alignment film are in direct contact with each other.

6. The optical member according to claim 1,
wherein the substrate includes a support.

7. The optical member according to claim 1,
wherein the liquid crystal material is a material obtained by curing a liquid crystal composition including a liquid crystal compound and a chiral agent.

8. The optical member according to claim 7,
wherein the liquid crystal composition includes a surfactant.

9. The optical member according to claim 8,
wherein the surfactant is a fluorine surfactant.

10. The optical member according to claim 1,
wherein a plurality of the dots are provided in a pattern shape on the surface of the substrate.

11. The optical member according to claim 1,
wherein a diameter of the dot is 20 to 200 μm.

12. The optical member according to claim 10,
wherein a diameter of the dot is 20 to 200 μm.

13. The optical member according to claim 1,
wherein a value obtained by dividing a maximum height of the dot by the diameter of the dot is 0.13 to 0.30.

14. The optical member according to claim 1,
wherein the dot has wavelength selective reflecting properties in which a center wavelength is present in an infrared range.

15. The optical member according to claim 10,
wherein the dot has wavelength selective reflecting properties in which a center wavelength is present in an infrared range.

16. The optical member according to claim 14,
wherein the dot has wavelength selective reflecting properties in which a center wavelength is present at a wavelength of 800 to 950 nm.

17. The optical member according to claim 1 which is transparent.

18. The optical member according to claim 15 which is transparent.

19. An image display device comprising the optical member according to claim 17.

20. An image display device comprising the optical member according to claim 18.
